(19) United States
(12) Patent Application Publication
(10) Pub. No.: US 2003/0196140 A1
(43) Pub. Date: Oct. 16, 2003

(54) Semiconductor integrated circuit

(76) Inventor: Hitoshi Kurosawa, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/242,460

(22) Filed: Sep. 13, 2002

(30) Foreign Application Priority Data
Apr. 12, 2002 (JP) 2002-111028

(51) Int. Cl. H04L 1/22

(52) U.S. Cl. 714/25

(57) ABSTRACT

A semiconductor integrated circuit has an inverter circuit for an input/output buffer connected to a pad portion of a port portion of a microcomputer, and an inverter circuit which performs an exclusive OR operation on the input and output of the former inverter circuit via a logic gate. The result of the exclusive OR operation is held in a register circuit installed in the microcomputer. The register value is read out to detect whether a buffer transistor included in the input/output-buffer inverter circuit is normal or not, so that a surge-oriented breakdown on the buffer transistor can be detected.

### BACKGROUND OF THE INVENTION

1. Field of the Invention

The present invention relates to a semiconductor integrated circuit including a microcomputer, and, more particularly, to a circuit which detects a surge-oriented destruction or breakdown of a transistor in a semiconductor device, such as a microcomputer, and application of that circuit.

2. Description of the Prior Art

The related art generally employs a method of detecting a surge-oriented breakdown of a transistor in a semiconductor integrated circuit, such as a microcomputer, by using a dedicated measuring circuit or device. In case where a transistor is broken down or damaged by a surge at the time a microcomputer operates, however, the method cannot ensure direct detection of whether or not the transistor is operating normally and merely allows later detection of the abnormal operation of the microcomputer originated from a secondary factor. In this case, the cause for the abnormal operation cannot be specified directly, disabling the proper operation of the microcomputer. This may lead to a serious problem.

FIG. 11 is a circuit diagram showing a conventional semiconductor integrated circuit and shows the construction of input/output terminal portions. In the drawing, reference numeral 100 denotes a microcomputer; and 1 denotes a CPU (Central Processing Unit). The CPU 1 fetches commands from a memory unit and decodes the commands to perform an operation and control. Reference numeral 2 denotes a memory; 3 denotes a port; and 51 denotes a pad. Reference symbols Tr4l and Tr42 designate respectively an output-buffer inverter circuit including an output buffer transistor, and an input-buffer inverter circuit including an input buffer transistor. R41 designates an input protection resistor. A diode D1 connected to a power supply side and a diode D2 connected to a ground side constitute a protection diode 6. The CPU 1 and the memory 2 are connected together to the port 3 via an internal bus and to an I/O port which includes the input/output buffer transistors.

The operation of the semiconductor integrated circuit will be discussed below.

When an input applied from the pad 51 is higher than the supply voltage by at least a predetermined level, the diode D1 is turned on. Likewise, when the input is lower than the ground level by at least a predetermined level, the diode D2 is turned on. As the protection diode 6 including the diodes D1 and D2 is activated when the input exceeds a given voltage level, the transistors included in the inverter circuits Tr41 and Tr42 can be protected against a surge-oriented breakdown with respect to a surge that has a predetermined input level.

Because the conventional semiconductor integrated circuit including a microcomputer is constructed in the above-described manner, a surge-oriented breakdown on the microcomputer should be detected by an external peripheral circuit or detected afterwards by a measuring device and the microcomputer itself cannot detect whether a surge-oriented breakdown has occurred or not.

Specifically, according to the prior art, in case where the input/output buffer transistor of the port 3 or the protection diode is damaged by a surge applied from the pad 51 of the microcomputer 100, a peripheral circuit external to the microcomputer should determine based on a signal from the port 3 whether or not the pad 51 is actually operating as expected and detect an abnormality of the port 3. There is no particular effective means known that allows the CPU 1 incorporated in the microcomputer 100 to find out the abnormality.

Japanese Patent Laid-Open No. 2000-29859 discloses a semiconductor integrated circuit which generates an interruption when the output signal level of a microcomputer differs from the intended output level due to a destruction or the like on an output terminal, so that the microcomputer can detect an abnormality inside and copes with the abnormality. This operation is accomplished as an interruption control circuit controls an interruption of the CPU via a logic gate in accordance with the comparison result from a comparison circuit.

At present, there is no practical means to design and manufacture a microcomputer which never causes a surge-oriented breakdown on transistors. In view of designing a highly reliable microcomputer, therefore, there is a great significance for a microcomputer itself to have some means for directly detecting if there is any transistor which is destructed by a surge.

### SUMMARY OF THE INVENTION

The present invention is made to solve the aforementioned drawbacks, and it is therefor an object of the invention to provide a semiconductor integrated circuit which allows a microcomputer itself to be detectable in real time if there occurs a surge-oriented breakdown.

A semiconductor integrated circuit according to the invention includes a buffer transistor connected to a pad portion of a microcomputer; a detection section for performing an arithmetic operation on an input and an output of the buffer transistor via a logic gate; and a memory section for holding a result of the arithmetic operation performed by the detection section, whereby it is detected from the result whether the buffer transistor is normal or abnormal.

Thus, This allows to detect in real time whether the transistor is normal or not even while the microcomputer is in operation, thereby implementing promptly an adequate measure at the time of a transistor breakdown by a surge. In addition, the location of a failure is easily determined, which may be useful in specifying a cause of a problem upon analyzing the problem.

Another semiconductor integrated circuit according to the invention includes a plurality of circuits each including a buffer transistor connected to a pad portion of the microcomputer, a detection section for performing an exclusive OR operation on an input and an output of the buffer transistor and power supply cutoff means for cutting off power supply to the buffer transistor according to an output of the detection section, whereby in case where the output of the detection section of one of the plurality of circuits is abnormal, power supply to the buffer transistor is cut off and that circuit is switched to another circuit.

Thus, this allows to ensure the continuous operation of the microcomputer by switching the abnormal circuit to a spare circuit, in addition to the advantage of suppressing an unprepared supply current to minimize the influence of the abnormality on a peripheral circuit or device external to the microcomputer.

### BRIEF DESCRIPTION OF THE DRAWINGS

FIG. 1 is a circuit diagram showing a semiconductor integrated circuit according to a first embodiment of the invention;

FIG. 2 is a circuit diagram showing a semiconductor integrated circuit according to a second embodiment of the invention;

FIG. 3 is a circuit diagram showing a semiconductor integrated circuit according to a third embodiment of the invention;

FIG. 4 is a circuit diagram showing a semiconductor integrated circuit according to a fourth embodiment of the invention;

FIG. 5 is a circuit diagram showing a semiconductor integrated circuit according to a fifth embodiment of the invention;

FIG. 6 is a circuit diagram showing a semiconductor integrated circuit according to a sixth embodiment of the invention;

FIG. 7 is a circuit diagram showing a semiconductor integrated circuit according to a seventh embodiment of the invention;

FIG. 8 is a circuit diagram showing a semiconductor integrated circuit according to an eighth embodiment of the invention;

FIG. 9 is a circuit diagram showing a semiconductor integrated circuit according to a ninth embodiment of the invention;

FIG. 10 is a circuit diagram showing a semiconductor integrated circuit according to a tenth embodiment of the invention; and

FIG. 11 is a circuit diagram showing a conventional semiconductor integrated circuit.

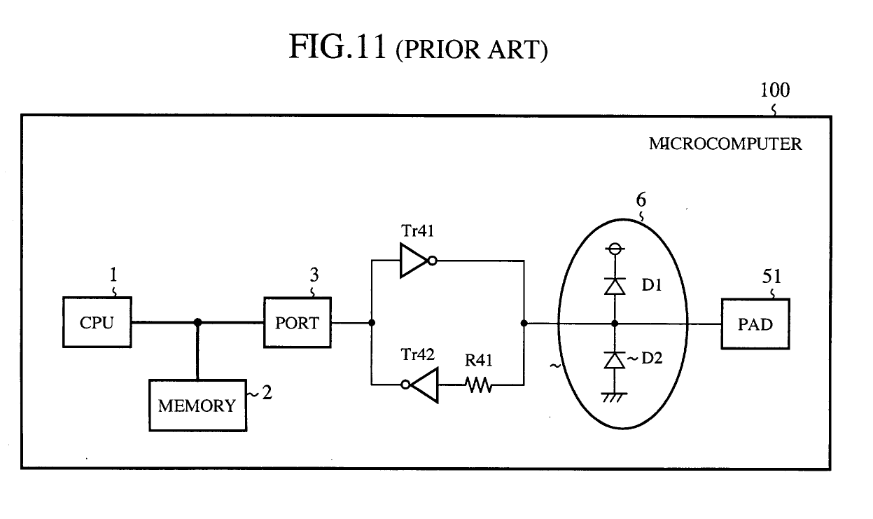

### DETAILED DESCRIPTION OF THE PREFERRED EMBODIMENTS

Preferred embodiments of the invention will now be described with reference to the accompanying drawings.

First Embodiment

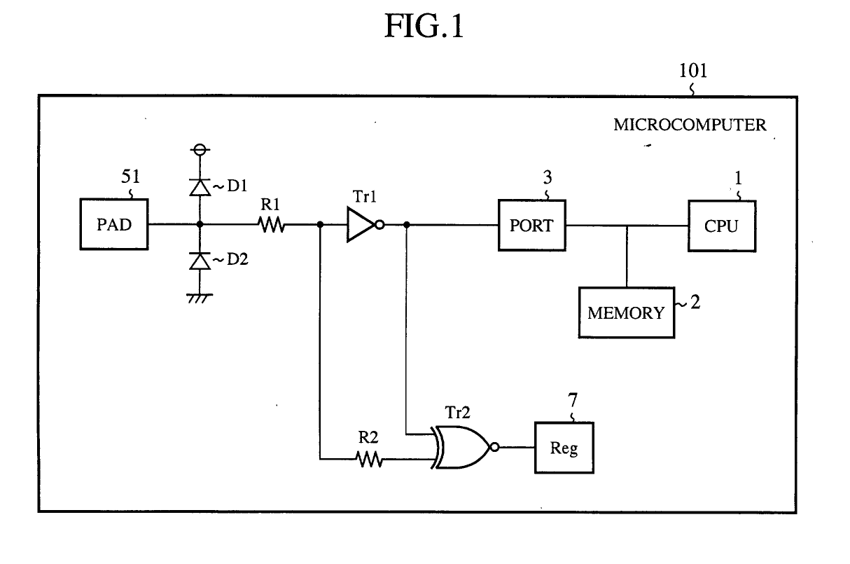

FIG. 1 is a circuit diagram showing a semiconductor integrated circuit according to a first embodiment of the invention. In the drawing, reference numeral 101 denotes a microcomputer; 1 denotes a CPU (interruption means, reset means, notification-to-outside means); and 2 denotes a memory or a memory unit, typified by ROM or RAM. Reference numeral 3 denotes a port which connects an internal circuit to an I/O port; 7 denotes a register circuit (memory section); 51 denotes a pad (pad portion). Reference symbol Tr1 designates an input-buffer inverter circuit (buffer transistor) including an input buffer transistor; Tr2 designates an exclusive OR inverter circuit (detection section); R1 and R2 each designates an input protection resistor; and D1 and D2 each designates a diode. The diode D1 connected to a power supply side and the diode D2 connected to a ground side constitute a protection diode. The input protection resistors R1 and R2 and the protection diode absorb a surge that is input to the pad 51, thereby preventing the transistors from surge-destruction.

The first embodiment detects whether or not the input buffer transistor (included in the inverter circuit Tr1 in this case) at the I/O of the microcomputer 101 is broken down by a surge by comparing the input potential with the output potential of the input buffer transistor. As a transistor which is predicted to be broken down by a surge is included in the inverter circuit Tr1, the installment of the circuit that detects if the transistor is operating normally or the exclusive OR inverter circuit Tr2 can make it possible to adequately cope with an abnormality of the transistor when detected.

The operation of the semiconductor integrated circuit will be discussed below.

The input and output potential levels of the inverter circuit Tr1 have an exclusive OR relationship and the output level of the exclusive OR inverter circuit Tr2 is always an L level when the inverter circuit Tr1 is normal. In case where the inverter circuit Tr1 does not operate normally and outputs always either an L level or H level due to some cause, the output level of the exclusive OR inverter circuit Tr2 may become an H level depending on the input level of the inverter circuit Tr1. Therefore, the register value in the register circuit 7 always holds an L level at the normal time, but the register value in the register circuit 7 may hold an H level when an abnormality occurs. In other words, the CPU 1 of the microcomputer 101 reads the value from the register circuit 7 and can detect that the inverter circuit Tr1 is abnormal when the read value has an H level.

The input protection resistor R2 serves to protect the input side of the exclusive OR inverter circuit Tr2 against a breakdown caused by a surge from the pad 51, and is provided with a large resistance within the range over which the protection capability is not lost.

The interconnection layout between an assumed destruction portion and the exclusive OR inverter circuit Tr2 which is the detection section is properly designed (such as the adjustment of the input impedance or the addition of a line capacitance), so that the detection section is not destructed by a surge.

According to the first embodiment, as described above, the exclusive OR inverter circuit Tr2 which serves as the detection section is installed in the microcomputer 101, so that it is possible to detect, in real time, if the transistor is normal even while the microcomputer 101 is in operation. This brings about such an advantage that a surge-oriented breakdown of the transistor included in the inverter circuit Tr1 can be dealt with adequately and promptly.

Further, it becomes easier to specify the location of a failure, which one can expect is very useful in specifying a cause for a problem at the time of analyzing the problem.

Second Embodiment

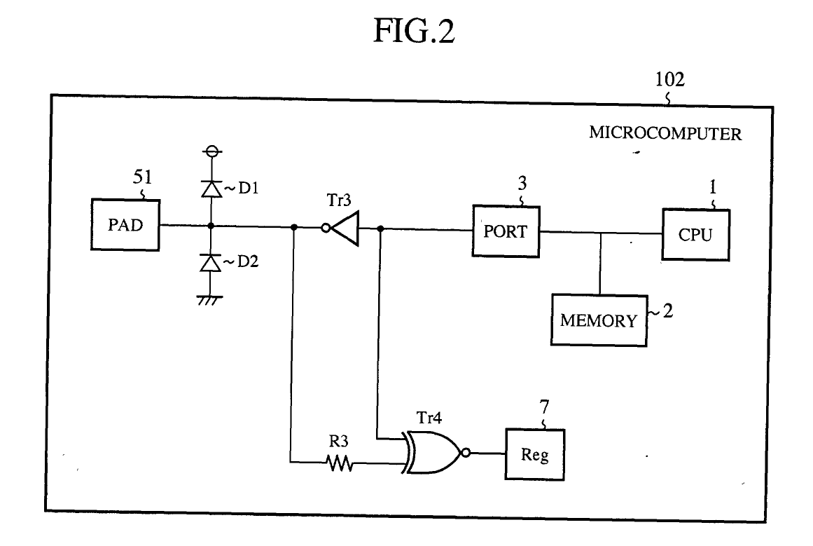

FIG. 2 is a circuit diagram showing a semiconductor integrated circuit according to a second embodiment of the invention. In the drawing, reference numeral 102 denotes a microcomputer; and 7 denotes a register circuit. Reference symbol Tr3 designates an output-buffer inverter circuit (buffer transistor) including an output buffer transistor; Tr4 designates an exclusive OR inverter circuit; and R3 designates an input protection resistor. Because the other components are the same as those of the first embodiment, their descriptions will be omitted; this will apply to the later descriptions of other embodiments.

The second embodiment detects whether or not the output buffer transistor (included in the inverter circuit Tr3 in this case) at the I/O of the microcomputer 102 is broken down by a surge by comparing the input potential with the output potential of the output buffer transistor. As a transistor which is predicted to be destructedby a surge is included in the inverter circuit Tr3, the installment of the circuit that detects if the transistor is operating normally or the exclusive OR inverter circuit Tr4 can make it possible to adequately cope with an abnormality of the transistor when detected.

The operation of the semiconductor integrated circuit will be discussed below.

The input and output potential levels of the inverter circuit Tr3 have an exclusive OR relationship and the output level of the exclusive OR inverter circuit Tr4 is always an L level when the inverter circuit Tr3 is normal. In case where the inverter circuit Tr3 does not operate normally and outputs always either an L level or H level due to some cause, the output level of the exclusive OR inverter circuit Tr4 may become an H level depending on the input level of the inverter circuit Tr3. Therefore, the register value in the register circuit 7 always holds an L level at the normal time, but the register value in the register circuit 7 may hold an H level when an abnormality occurs. In other words, the CPU 1 of the microcomputer 102 reads the value from the register circuit 7 and can detect that the inverter circuit Tr3 is abnormal when the read value has an H level.

The input protection resistor R3 serves to protect the input side of the exclusive OR inverter circuit Tr4 against a destruction caused by a surge from the pad 51, and is provided with a large resistance within the range over which the protection capability is not lost.

The interconnection layout between an assumed destruction portion and the exclusive OR inverter circuit Tr4 which is the detection section is properly designed (such as the adjustment of the input impedance or the addition of a line capacitance), so that the detection section is not destructed by a surge.

According to the second embodiment, as described above, the exclusive OR inverter circuit Tr4 which serves as the detection section is installed in the microcomputer 102, so that it is possible to detect, in real time, if the microcomputer 102 is normal even while the microcomputer 102 is in operation. This brings about such an advantage that a surge-oriented breakdown of the transistor included in the inverter circuit Tr3 can be dealt with adequately and promptly.

Further, it becomes easier to specify the location of a failure, which can be expected to be very useful in specifying a cause for a problem at the time of analyzing the problem.

Third Embodiment

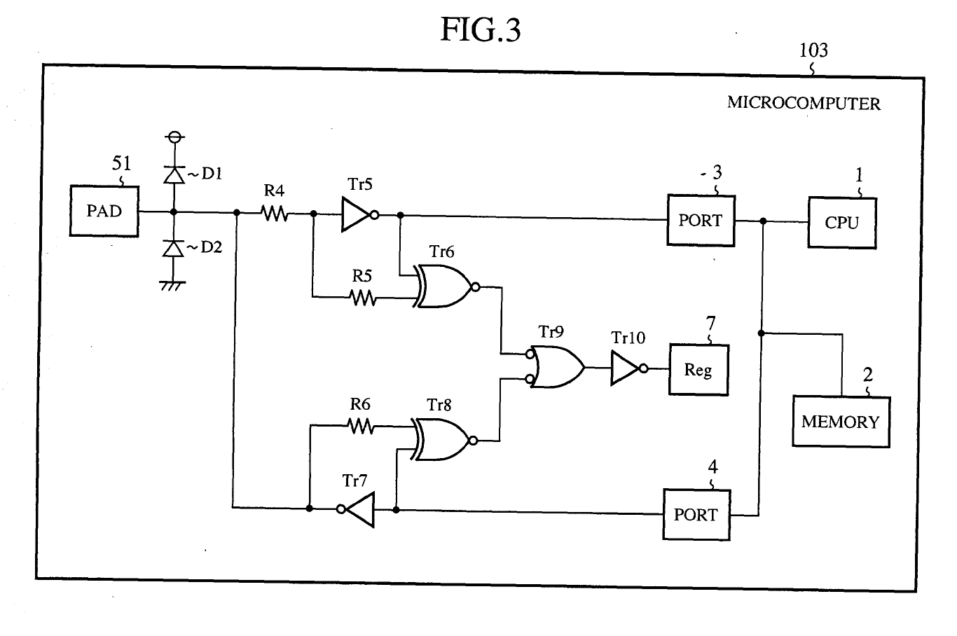

FIG. 3 is a circuit diagram showing a semiconductor integrated circuit according to a third embodiment of the invention. In the drawing, reference numeral 103 denotes a microcomputer; and 3 and 4 each denotes a port. Reference symbols R4 to R6 each designates an input protection resistor, and Tr5 and Tr7 respectively denote an input-buffer inverter circuit including an input buffer transistor and an output-buffer inverter circuit including an output buffer transistor. Both inverter circuits Tr5 and Tr7 constitute an input/output inverter circuit (input/output buffer transistor). Reference symbols Tr6 and Tr8 both designate exclusive OR inverter circuits; Tr9 designates a NAND gate which has a negative logic on the input side and a positive logic on the output side; Tr10 designates an inverter circuit; and 7 denotes a register circuit. Because the other components are the same as those of the embodiments described above, their descriptions will be omitted.

According to the third embodiment, the ports that serve as input and outputs of the microcomputer 103 are equipped with the same detection capabilities of the first and second embodiments. While the basic structure of the third embodiment is the same as the structures of the first and second embodiments, the third embodiment differs from the first and second embodiments in that abnormality detection results from the input-buffer and output-buffer inverter circuits Tr5 and Tr7 or the outputs of the exclusive OR inverter circuits Tr6 and Tr8 are ORed by the NAND gate Tr9 and the result of the OR operation is held in the register circuit 7.

The operation of the semiconductor integrated circuit will be discussed below.

In case where the input buffer transistor included in the input-buffer inverter circuit Tr5 is destructed by a surge and does not operate properly, for example, the output level of the exclusive OR inverter circuit Tr6 may have an H level, not an L level which occurs when the output level is normal, depending on the input level of the input-buffer inverter circuit Tr5. Likewise, in case where the output buffer transistor included in the output-buffer inverter circuit Tr7 does not operate properly, the output level of the exclusive OR inverter circuit Tr8 may have an H level which occurs when the output level is abnormal, depending on the input level of the output-buffer inverter circuit Tr7.

The H-level outputs of both exclusive OR inverter circuits Tr6 and Tr8 at the abnormal time are ORed by the NAND gate Tr9 and the result of the OR operation is held in the register circuit 7.

According to the third embodiment, as described above, the CPU 1 of the microcomputer 103 can check two abnormal detection results of the input buffer transistor and output buffer transistor respectively included in the input-buffer and output-buffer inverter circuits Tr5 and Tr7 by referring to a single register value. This makes it possible to adequately deal with surge-oriented breakdowns of those transistors faster.

Further, it becomes easier to specify the location of a failure, which can be expected to be very useful in specifying a cause for a problem at the time of analyzing the problem.

Fourth Embodiment

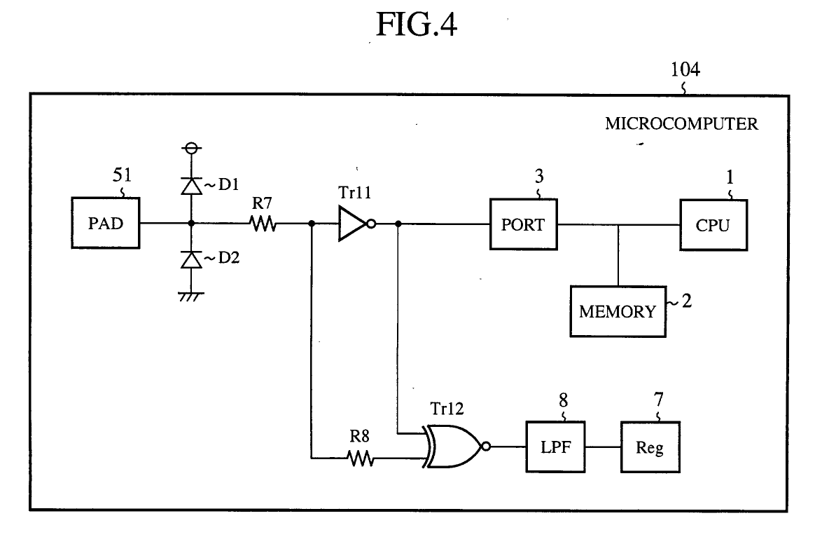

FIG. 4 is a circuit diagram showing a semiconductor integrated circuit according to a fourth embodiment of the invention. In the drawing, reference numeral 104 denotes a microcomputer; reference symbols R7 and R8 each designates an input protection resistor; Tr11 denotes an input-buffer inverter circuit including an input buffer transistor; Tr12 designates an exclusive OR inverter circuit; 7 denotes a register circuit; and 8 denotes an LPF circuit (erroneous detection preventing means) which includes a low-pass filter (LPF).

The fourth embodiment has the LPF circuit 8 added to the structure of the first embodiment to avoid erroneous detection that is caused when the register value in the register circuit 7 temporarily becomes an H level as the input/output transistor at the I/O port of the microcomputer 104 operates.

The operation of the semiconductor integrated circuit will be discussed below.

When the input level of the pad 51 does not vary, the output level of the exclusive OR inverter circuit Tr12 does not change. When the input level of the pad 51 varies and becomes close to the input threshold value of the inverter circuit Tr11 and the input level of the exclusive OR inverter circuit Tr12 becomes the same level, there is a time at which the output level of the exclusive OR inverter circuit Tr12 becomes an H level temporarily. If the CPU 1 reads the register value at this time, the CPU 1 may erroneously detect that the input buffer transistor in the inverter circuit Tr11 is abnormal, although this input buffer transistor is operating normally.

The period in which the temporary H level occurs is an instant in the vicinity of the input threshold value of the inverter circuit Tr11 in the duration from the point at which the output level of the pad 51 becomes an H level to the point at which the output level of the pad 51 becomes an L level, or an instant in the vicinity of the input threshold value of the inverter circuit Tr11 in the duration from the point at which the output level of the pad 51 becomes an L level to the point at which the output level of the pad 51 becomes an H level. The LPF circuit 8 connected to the output of the exclusive OR inverter circuit Tr12 can eliminate the temporary H level duration. As the output of the LPF circuit 8 is held in the register circuit 7 and the register value is read out by the CPU 1, the CPU 1 can determine an abnormality of the input buffer transistor in the inverter circuit Tr11 without erroneous detection even while the input level of the pad 51 is changing.

If the second and third embodiments take a structure similar to the structure of the fourth embodiment, the CPU 1 can determine an abnormality of the input buffer transistor without erroneous detection. That is, inserting the LPF circuit 8 between the output of the exclusive OR inverter circuit Tr4 and the input of the register circuit 7 in FIG. 2, or between the output of the inverter circuit Tr10 and the input of the register circuit 7 in FIG. 3 can provide the second or third embodiment with the same capability as that of the fourth embodiment.

According to the fourth embodiment, as apparent from the foregoing description, as the LPF circuit 8 is inserted between the exclusive OR inverter circuit Tr12 or the detection section and the register circuit 7 or the memory section, a noise-originated erroneous operation is suppressed and even when the input level of the inverter circuit Tr11 changes, the change can be detected in real time. In other words, the fourth embodiment can provide such an advantage as to be able to prevent the CPU 1 from making an erroneous detection of an abnormality in addition to the advantage of the first embodiment.

Fifth Embodiment

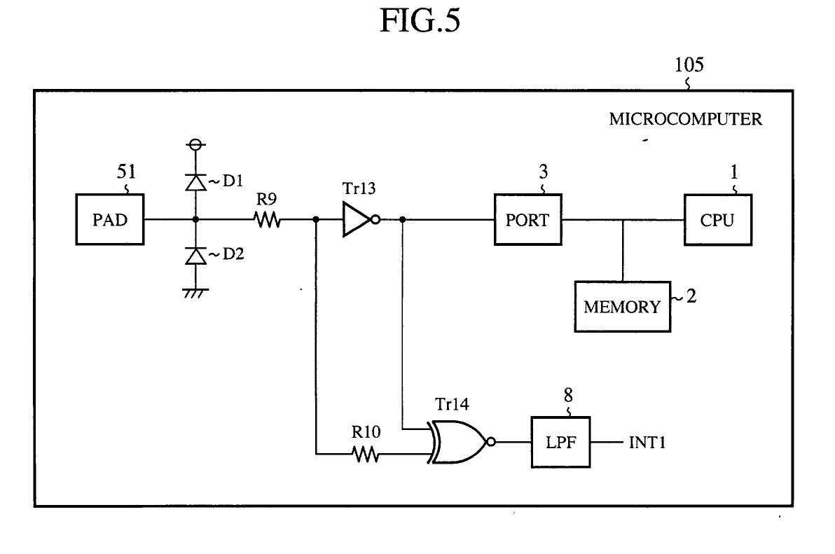

FIG. 5 is a circuit diagram showing a semiconductor integrated circuit according to a fifth embodiment of the invention. In the drawing, reference numeral 105 denotes a microcomputer; reference symbols R9 and R10 each designates an input protection resistor; Tr13 designates an input-buffer inverter circuit including an input buffer transistor; Tr14 designates an exclusive OR inverter circuit; and 8 denotes an LPF circuit which includes a low-pass filter (LPF). The fifth embodiment is the same as the fourth embodiment except that the output of the LPF circuit 8 becomes an interruption signal INT1.

Unlike the fourth embodiment in which the CPU 1 determines whether an input/output buffer transistor is normal or abnormal based on a register value read from the register circuit 7, the fifth embodiment is designed in such a way that the CPU 1 serves as interruption means to interrupt the internal circuit of the microcomputer 105 when an abnormality occurs and can determine the abnormality by performing an interruption process.

Interruption is to interrupt a program which is currently running and activate an interruption program with respect to the cause for the interruption in response to a request external to the system or due to the state that occurs in the CPU or the state that occurs in the input/output device. A sequence of processes performed by the interruption program is called an interruption process.

The operation of the semiconductor integrated circuit will be discussed below.

The output of the LPF circuit 8 is used as the interruption signal INT1 for the microcomputer 105. When it is determined that the input buffer transistor is abnormal as the output of the exclusive OR inverter circuit Tr14 has an H level, the CPU 1 is interrupted by the interruption signal INT1 and detection of a surge-oriented destruction of the transistor is carried out in the interruption process.

While the occurrence of an abnormality is determined on the software basis when the CPU 1 reads a register value from the register circuit 7 in the first to fourth embodiments, the CPU 1 just needs to cope with an abnormality only when the abnormality occurs in the fifth embodiment, which brings about an advantage of reducing the burden on the CPU 1.

Adapting the structure of the fifth embodiment to the first to fourth embodiments can allow the CPU 1 to deal with an abnormality through the interruption process of the CPU 1 only when the abnormality occurs.

Sixth Embodiment

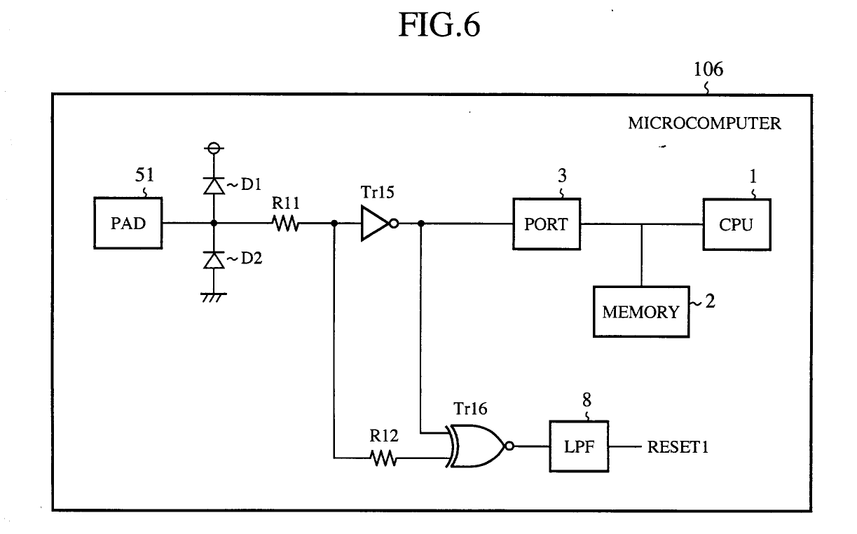

FIG. 6 is a circuit diagram showing a semiconductor integrated circuit according to a sixth embodiment of the invention. In the drawing, reference numeral 106 denotes a microcomputer; reference symbols R11 and R12 each designates an input protection resistor; Tr15 designates an input-buffer inverter circuit including an input buffer transistor; Tr16 designates an exclusive OR inverter circuit; and 8 denotes an LPF circuit which includes a low-pass filter (LPF). The sixth embodiment is the same as the fourth embodiment except that the output of the LPF circuit 8 becomes a reset signal RESET1.

Unlike the fourth embodiment in which the CPU 1 determines whether an input/output buffer transistor is normal or abnormal based on a register value read from the register circuit 7, the sixth embodiment is designed in such a way that the CPU 1 serves as reset means to reset the microcomputer 106 when an abnormality occurs.

The operation of the semiconductor integrated circuit will be discussed below.

The output of the LPF circuit 8 is used as the reset signal RESET1 for the microcomputer 106. When it is determined that the input buffer transistor is abnormal as the output of the exclusive OR inverter circuit Tr16 has an H level, the microcomputer 106 is reset by the reset signal RESET1. While an abnormality is finally dealt with the CPU 1 in the first to fifth embodiments, an abnormality is dealt with hardware alone in the sixth embodiment so that even the worst case where software does not operate properly can be coped with by resetting the microcomputer 106.

Adapting the structure of the sixth embodiment to the first to fifth embodiments can permit the microcomputer 106 to be reset when an abnormality occurs.

According to the sixth embodiment, as apparent from the above, when it is determined that an input/output buffer transistor is abnormal, the microcomputer 106 is reset by hardware alone using the reset signal RESET1. This can provide an advantage that the microcomputer 106 can be reset even in the worst case where the proper operation of software is not expected.

Seventh Embodiment

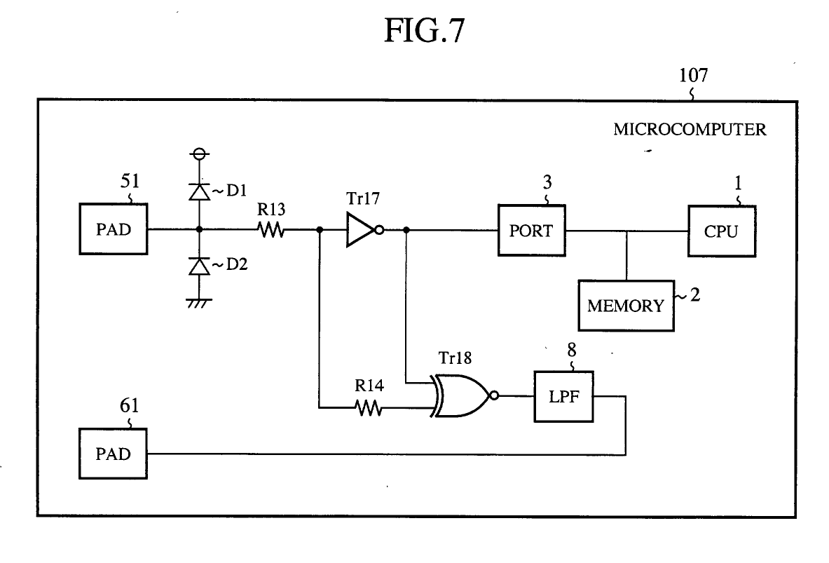

FIG. 7 is a circuit diagram showing a semiconductor integrated circuit according to a seventh embodiment of the invention. In the drawing, reference numeral 107 denotes a microcomputer; reference symbols R13 and R14 each designates an input protection resistor; Tr17 designates an input-buffer inverter circuit including an input buffer transistor; Tr18 designates an exclusive OR inverter circuit; and 8 denotes an LPF circuit which includes a low-pass filter (LPF). Reference numeral 61 denotes a pad (another pad portion) which is the output pad of the microcomputer 107.

Unlike the fourth embodiment in which the CPU 1 determines whether an input/output buffer transistor is normal or abnormal based on a register value read by the CPU 1, the seventh embodiment is designed in such a way that the CPU 1 is allowed to serve as notification-to-outside means capable of sending a signal out of the microcomputer 107 and a circuit or device external to the microcomputer 107 is allowed to determine an abnormality.

The operation of the semiconductor integrated circuit will be discussed below.

The output of the LPF circuit 8 is output to the pad 61 of the microcomputer 107. When it is determined that the input buffer transistor Tr17 is abnormal as the output of the exclusive OR inverter circuit Tr18 goes to an H level, an H level is output to the output pad 61 of the microcomputer 107 and a peripheral circuit or device which is monitoring the event can cope with the abnormality. As an abnormality of the microcomputer 107 is notified outside the microcomputer 107, the abnormality can be dealt with not only by the microcomputer 107 but also by the entire system.

Adapting the structure of the seventh embodiment to the first to fourth embodiments can allow an H level to be output to the output pad 61 of the microcomputer 107 when an abnormality occurs, so that the peripheral circuit or device that is monitoring the event can cope with the abnormality.

Employing both the seventh embodiment and any one of the first to sixth embodiments can allow an abnormality to be dealt with by both inside and outside the microcomputer.

As apparent from the above, the seventh embodiment is designed in such a way that the result of detection by the exclusive OR inverter circuit Tr18 is sent outside the microcomputer 107. This brings about such an advantage that a peripheral circuit external to the microcomputer can detect a surge-oriented destruction on the transistor.

Eighth Embodiment

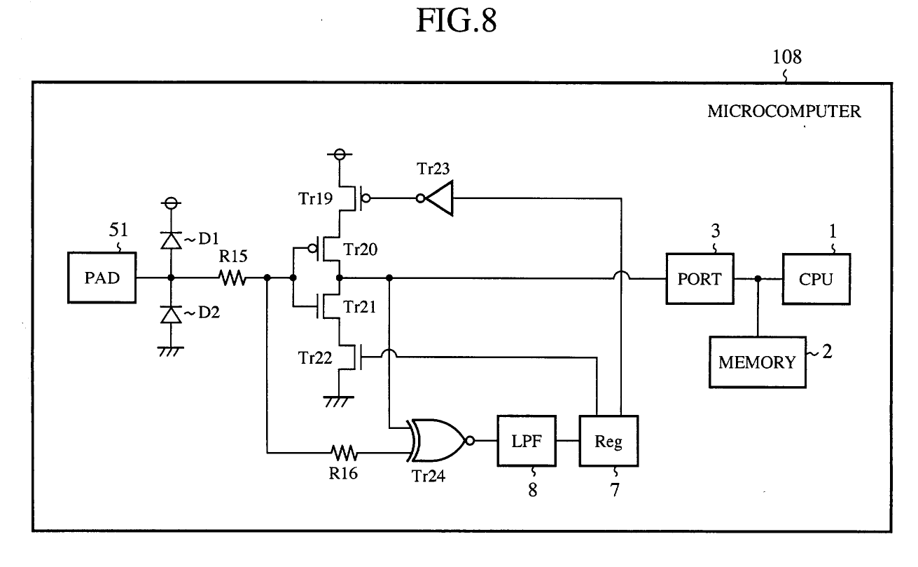

FIG. 8 is a circuit diagram showing a semiconductor integrated circuit according to an eighth embodiment of the invention. In the drawing, reference numeral 108 denotes a microcomputer; reference symbols R15 and R16 each designates an input protection resistor; Tr19 and Tr20 each designates a P channel MOS (PMOS) transistor; and Tr21 and Tr22 each designates a N channel MOS (NMOS) transistor. The transistors Tr19 to Tr22 constitute a buffer transistor. Reference symbol Tr23 designates an inverter circuit whose output is connected to the gate of the transistor Tr19, Tr24 designates an exclusive OR inverter circuit; 7 denotes a register circuit; and 8 denotes an LPF circuit. The PMOS transistor Tr19 serves, together with the inverter circuit Tr23, as power supply cutoff means.

The eighth embodiment is the fourth embodiment which can allow the CPU 1 to determine whether the input/output buffer transistor is normal or abnormal based on a register value read from the register circuit 7 and to which the function of the power supply cutoff means capable of cutting off power supply to the input/output buffer transistor at the time of an abnormality, such as the occurrence of a surge-oriented destruction, is added, thereby minimizing an unprepared surge-oriented increase in supply current and the influence of the surge-oriented destruction on a peripheral circuit or device external to the microcomputer 108.

The operation of the semiconductor integrated circuit will be discussed below.

When an abnormality occurs in the transistors Tr20 and Tr21, the output of the exclusive OR inverter circuit Tr24 becomes an H level at which time the signal that passes through the register circuit 7 turns off the PMOS transistor Tr19 via the inverter circuit Tr23 and turns off the NMOS transistor Tr22, thereby inhibiting power supply to the transistors Tr20 and Tr21. The register circuit 7 is designed in such a way that once the register circuit 7 goes to an H level, it does not go to an L level automatically but can be set to an L level again when reset or by writing an L level in the register circuit 7 by software.

As power is not supplied to the transistors Tr20 and Tr21, an unprepared increase in supply current is prohibited and a careless current flow between the pad 51 and an external circuit of the microcomputer 108 does not occur even if the gates of the transistors Tr20 and Tr21 are destructed and are thus short-circuited to the power supply and the ground.

The CPU 1 can detect that there is an abnormality in the transistors Tr20 and Tr21 by reading a register value from the register circuit 7.

If a structure similar to the structure of the eighth embodiment is adapted to the first to fourth embodiments, it is possible to cut off power supply to an abnormal input/output buffer transistor when an abnormality occurs, eliminating an unprepared increase in supply current, and minimize the influence on the peripheral circuit or device external to the microcomputer 108.

As described above, the eighth embodiment is designed in such a way that power supply to the buffer transistor is cut off when an abnormality is detected based on the result of detection by the exclusive OR inverter circuit Tr24. This brings about an advantage of eliminating an unprepared increase in supply current and minimizing the influence on the external peripheral circuit or device.

Ninth Embodiment

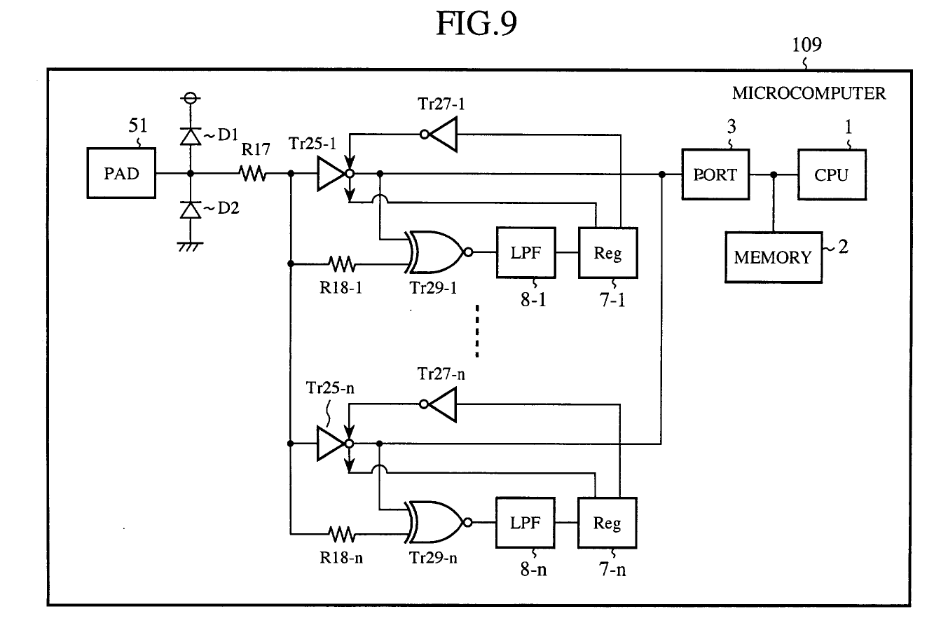

FIG. 9 is a circuit diagram showing a semiconductor integrated circuit according to a ninth embodiment of the invention. In the drawing, reference numeral 109 denotes a microcomputer; reference symbols R17 and R18-1 to R18-n (n: a positive integer) each designates an input protection resistor; Tr25-1 to Tr25-n each designates a clocked inverter including a buffer transistor; likewise, Tr27-1 to Tr27-n each designates an inverter circuit; Tr29-1 to Tr29-n each designates an exclusive OR inverter circuit; 7-1 to 7-n each denotes a register circuit; and 8-1 to 8-n each denotes a LPF circuit.

The ninth embodiment is so designed as to have plural (n in this example) structures of the eighth embodiment as redundant circuits, so that even if the buffer transistor in the clocked inverter Tr25-1, for example, becomes abnormal due to a surge-oriented destruction or the like, the microcomputer 109 can be operated without problem as a whole by switching the abnormal clocked inverter to any of the other (n−1)th normal circuits.

The operation of the semiconductor integrated circuit will be discussed below.

When an abnormality occurs in the clocked inverter Tr25-1, the output of the exclusive OR inverter circuit Tr29-1 becomes an H level at which time the clocked inverter Tr25-1 is turned off, thus inhibiting power supply thereto. The register circuit 7-1 is designed in such a way that once the register circuit 7-1 goes to an H level, it does not go to an L level automatically but can be set to an L level again when reset or by writing an L level in the register circuit 7-1 by software. As power is not supplied to the clocked inverter Tr25-1, an unprepared increase in supply current is prohibited and a careless current flow between the pad 51 and an external circuit of the microcomputer 109 does not occur even if the gate of the clocked inverter Tr25-1 is broken down and is thus short-circuited to the power supply and the ground.

The CPU 1 can detect that there is an abnormality in the clocked inverter Tr25-1 by reading a register value from the register circuit 7-1.

As plural (n) circuits with the above-described structures are installed, when the clocked inverter Tr25-1, for example, is abnormal, it is switched to another clocked inverter Tr25-n which in turn becomes valid.

The register values in the register circuits 7-1 to 7-n can be rewritten by software and can be set in such a way that only one of the register circuits operates.

If a structure similar to the structure of the ninth embodiment is adapted to the first to fourth embodiments, it is possible to cut off power supply to an abnormal input/output buffer transistor when an abnormality occurs, eliminating an unprepared increase in supply current, minimize the influence on the peripheral circuit or device external to the microcomputer 109 and ensure continuous operation of the microcomputer 109 by switching the abnormal circuit to any spare circuit.

As described above, because the ninth embodiment is designed in such a way to have a plurality of structures of the eight embodiment that have a capability of the power supply cutoff means, when an abnormality occurs, it is possible to stop power supply to the abnormal input/output buffer transistor, thereby eliminating the careless consumption of the supply current and the influence on the peripheral circuit and device, and switch the abnormal circuit to another spare circuit, thereby ensuring continuous operation of the microcomputer 109.

Tenth Embodiment

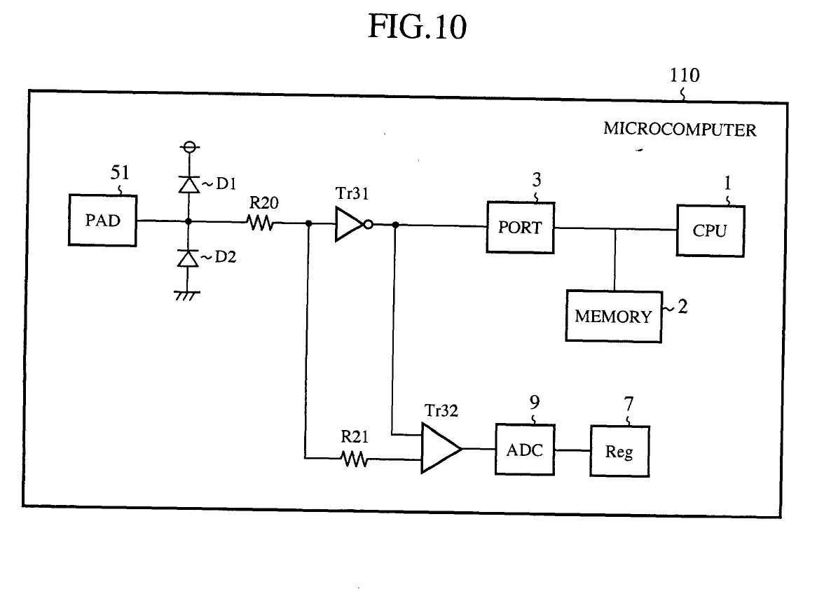

FIG. 10 is a circuit diagram showing a semiconductor integrated circuit according to the tenth embodiment of the invention. In the diagram, reference numeral 110 denotes a microcomputer; reference symbols R20 and R21 each designates an input protection resistor; Tr31 designates an input-buffer inverter circuit including an input buffer transistor; Tr32 designates an amplifier circuit; 9 denotes an AD converter (ADC); and 7 denotes a register circuit.

The tenth embodiment is basically the same in structure as the first embodiment but differs therefrom in that the exclusive OR inverter circuit Tr2 in FIG. 1 is replaced with the amplifier circuit Tr32. It is detected whether or not the input buffer transistor (or the output buffer transistor) at the I/O port of the microcomputer 110 is destructed by a surge by comparing the input potential and output potential of the input buffer transistor with each other by the amplifier circuit Tr32.

The operation of the semiconductor integrated circuit will be discussed below.

A logical element is replaced with the amplifier circuit Tr32, it is possible to detect a minute level difference in input level and detect the level of a surge-oriented breakdown on the input buffer transistor even if it is not broken completely. At that time, the register circuit 7 should be designed to be able to hold multi-value levels of a digital value, in the form of plural bits, which is acquired by digital conversion of the analog output value of the amplifier circuit Tr32 by the AD converter 9. This can ensure detection of a minute leak which is caused by a surge-oriented breakdown or destruction.

Adapting the structure of the tenth embodiment to the second to ninth embodiments can ensure accurate determination of an abnormality when occurred.

As described above, the tenth embodiment is designed in such a way that the exclusive OR inverter circuit Tr2 or the detection section is replaced with the amplifier circuit Tr32, providing an advantage of ensuring detection of a minute leak which is caused by a surge-oriented breakdown.

What is claimed is:

1. A semiconductor integrated circuit including a microcomputer incorporating at least a CPU and memory, comprising:
a buffer transistor connected to a pad portion of said microcomputer;
a detection section for performing an arithmetic operation on an input and an output of said buffer transistor via a logic gate; and
a memory section for holding a result of said arithmetic operation performed by said detection section,
whereby it is detected from said result whether said buffer transistor is normal or abnormal.

2. The semiconductor integrated circuit according to claim 1, wherein said logic gate performs an exclusive OR operation.

3. The semiconductor integrated circuit according to claim 1, wherein said buffer transistor connected to said pad portion includes an input buffer transistor or an output buffer transistor.

4. The semiconductor integrated circuit according to claim 1, wherein said buffer transistor connected to said pad portion comprises an input/output buffer transistor and has an operation section, provided between an output of said detection section and said memory section, for performing an OR operation.

5. The semiconductor integrated circuit according to claim 1, wherein said buffer transistor constitutes an inverter circuit.

6. The semiconductor integrated circuit according to claim 1, wherein said detection section comprises an exclusive OR inverter circuit.

7. The semiconductor integrated circuit according to claim 4, wherein said operation section comprises a NAND gate.

8. The semiconductor integrated circuit according to claim 1, further comprising erroneous detection preventing means provided between an output of said detection section and said memory section.

9. The semiconductor integrated circuit according to claim 8, wherein said erroneous detection preventing means comprises a low-pass filter circuit.

10. The semiconductor integrated circuit according to claim 1, further comprising interruption means which uses an output of said detection section to interrupt said CPU.

11. The semiconductor integrated circuit according to claim 8, further comprising interruption means which uses an output of said erroneous detection preventing means to interrupt said CPU.

12. The semiconductor integrated circuit according to claim 2, further comprising interruption means which uses an output of said memory section to interrupt said CPU.

13. The semiconductor integrated circuit according to claim 1, further comprising reset means which uses an output of said detection section to reset said microcomputer.

14. The semiconductor integrated circuit according to claim 1, further comprising notification-to-outside means for outputting an output of said detection section to a peripheral circuit external to said microcomputer.

15. The semiconductor integrated circuit according to claim 14, wherein an operation of said notification-to-outside means is carried out via another pad portion of said microcomputer.

16. The semiconductor integrated circuit according to claim 1, further comprising power supply cutoff means for cutting off power supply to said buffer transistor according to an output of said detection section.

17. A semiconductor integrated circuit including a microcomputer incorporating at least a CPU and memory, comprising:
a plurality of circuits each including a buffer transistor connected to a pad portion of said microcomputer, a detection section for performing an exclusive OR operation on an input and an output of said buffer transistor and power supply cutoff means for cutting off power supply to said buffer transistor according to an output of said detection section, whereby in case where said output of said detection section of one of said plurality of circuits is abnormal, power supply to said buffer transistor is cut off and that circuit is switched to another circuit.

18. The semiconductor integrated circuit according to claim 17, wherein said detection section which performs an exclusive OR operation is replaced with an amplifier.

19. The semiconductor integrated circuit according to claim 18, wherein said amplifier has a memory section for holding a result of an operation of said amplifier via an AD converter and reads out a value held in said memory section to detect a degree of abnormality of said buffer transistor.
